(19) United States
(12) Patent Application Publication
(10) Pub. No.: US 2012/0112699 A1
(43) Pub. Date: May 10, 2012

(54) METHOD AND CHARGING DEVICE FOR CHARGING AT LEAST TWO BATTERIES

(75) Inventors: Franz Huber, Markt Wald (DE); Eduard Sever, Ludesch (AT); Dragomir Ljubojevic, St. Gallen (CH)

(73) Assignee: Hilti Aktiengesellschaft, Schaan (LI)

(21) Appl. No.: 13/290,396

(22) Filed: Nov. 7, 2011

(30) Foreign Application Priority Data
Nov. 8, 2010 (DE) 10 2010 043 585.6

(51) Int. Cl. H02J 7/00

(52) U.S. Cl. 320/112; 320/160

(57) ABSTRACT

A method for charging at least two batteries each having at least one cell is disclosed. During a first charging phase, batteries are charged sequentially to a first charge status and afterwards batteries are charged during a second charging phase sequentially to a second, higher charge status. The first charging phase is begun with the battery having the lowest charge status. In addition, a charging device for carrying out the method according to the invention and a mobile electric appliance including such a charging device are disclosed.

This application claims the priority of German Patent Document No. 10 2010 043 585.6, filed Nov. 8, 2010, the disclosure of which is expressly incorporated by reference herein.

### BACKGROUND AND SUMMARY OF THE INVENTION

The invention relates to a method for charging at least two batteries each having at least one cell, wherein during a first charging phase batteries are charged sequentially to a first charge status and afterwards batteries are charged during a second charging phase sequentially to a second, higher charge status. In addition, the invention relates to a charging device for charging at least two batteries each having at least one cell, comprising a controller, which is set up to charge, during a first charging phase, batteries sequentially to a first charge status and afterwards, during a second charging phase, to charge batteries sequentially to a second, higher charge status. In addition, the invention relates to a mobile electric appliance comprising an electric consumer and a power connector as well as a charging device of the cited type. Finally, the invention relates to a set comprising at least one electric hand-held device and at least one mobile electric appliance of the cited type as well as several batteries that are interchangeable between the at least one electric hand-held device and the at least one mobile electric appliance.

Because of the steadily increasing number of mobile, electrically-operated devices, the demand for charging devices for accumulators (also known colloquially as a “batteries”) required to operate these devices is also rising. For example, German Patent Document DE 10 2009 001 670 A1 discloses a method for charging a number of batteries, which is designed for charging with constant current and increasing voltage during a first phase, and during a second phase following the first phase with constant voltage and falling current. In the case of the known method, the batteries are charged sequentially so that only one of the batteries is charged at a time. In this case, a battery is charged during the first phase and when the predetermined limit voltage is reached, charging of the battery in question is discontinued during the first phase, and charging is continued with another battery.

In addition, a vacuum cleaner is known from European Patent Document No. EP 1 419 723 B1, which has several battery bays for batteries, which may be used both in a vacuum cleaner as well as in other electric hand-held devices. The vacuum cleaner may be supplied both by the power supply system as well as independently using the batteries.

The disadvantage of the known charging circuits is that they are not optimized for the quickest possible transfer of energy to the batteries. DE 10 2009 001 670 A1 proposes namely that all batteries be charged to a specific charge status during a first phase and they not be charged fully until during a second phase. Unfortunately, this course of action does not allow the optimum of the quickest possible transfer of energy to be achieved.

Therefore, the object of the invention is creating an improved method and an improved charging device for charging at least two batteries. In particular, in this case the transfer of energy is accelerated. In addition, the object of the invention is creating an improved mobile electric appliance as well as an improved set comprising an electric hand-held device and a mobile electric appliance of the cited type.

According to the invention, this object is attained with a method of the type cited at the outset, in which the first charging phase is begun with the battery having the lowest charge status.

The object of the invention is also attained with a charging device of the type cited at the outset, in which the controller is set up to begin the first charging phase with the battery having the lowest charge status.

In addition, the object of the invention is attained with a mobile electric appliance of the type cited at the outset, also comprising a charging device according to the invention and a switching device, which is prepared to connect the consumer and the charging device to the power connector, when the electric hand-held device is attached to the power supply system, and otherwise to connect a battery inserted into the battery bay to the consumer.

The term “mobile electric appliance” is understood in this connection as an electric appliance, which can be moved or displaced from one workplace to another workplace even when in operation.

Finally, the object of the invention is attained by a set of the type cited at the outset, also comprising at least one mobile electric appliance according to the invention and several batteries interchangeable between the at least one electric hand-held device and the at least one mobile electric appliance.

This is achieved according to the invention in that the transfer of energy to batteries occurs as quickly as possible. In contrast to the prior art, charging is not started with just any battery or with the battery that just happens to be inserted in the first battery bay, but with the battery that has the lowest charge status. In this way, it is possible for the transfer of energy to be accomplished very rapidly initially so that the batteries already have a “base charge” after a short time.

Advantageous embodiments and further developments of the invention are disclosed in the description in conjunction with the figures.

It is especially advantageous, if during the first charging phase, batteries having a charge status which falls short of the first charge status are charged, and during the second charging phase, batteries having a charge status which falls short of the second, higher charge status are charged. During the first charging phase, only those batteries need to be charged whose charge status before the beginning of the first charging phase is below the target charge status after termination of the first charging phase. For example, if a battery is charged to 90%, then during the first phase (in the foregoing example with the target charge status of 75%) it does not, of course, need to be charged or can even be discharged to 75%.

In addition, it is especially advantageous if, during an additional charging phase, the batteries having a charge status which falls short of an additional, higher charge status are charged sequentially to the additional, higher charge status. With one or more additional charging phases, all batteries are charged to 100% of their charging capacity. The additional charging phases are repeated with respectively increasing charge statuses until all batteries are fully charged. For example, the batteries may be charged to 65% during a first charging phase, to 80% during a second charging phase and then to 100%.

The method is terminated when all batteries have a charge status of 100%. Depending upon the charge status of the batteries inserted into the battery bays, the charge status of 100% may already be reached after the first, second or one of the additional charging phases. Because the method is terminated after reaching a charge status of 100%, supplied energy is not consumed uselessly.

It is especially advantageous if, during the first charging phase, the batteries are charged in an ascending order of their charge statuses before the beginning of the first charging phase. In this case, the first charging phase is not just begun with the battery having the lowest charge status, but all additional batteries are charged in the order of their charge statuses from the least charged to the most charged battery.

It is also especially advantageous if, during the second charging phase as well as during the additional charging phases, the batteries are charged in the ascending order of the charge statuses before the beginning of the first charging phase. This makes is possible to charge the batteries in an especially efficient manner.

It is also advantageous if the first charge status, the second charge status and/or the additional charge statuses are predetermined as a percentage value. For example, all batteries may be charged during the first charging phase sequentially to 75% and afterwards, during a second or additional charging phase, all batteries may be charged sequentially to 100%. The advantage of this is that the batteries are especially receptive during the first charging phase and therefore the base charge may take place very quickly. Of course, the specified values should be viewed as merely illustrative. Naturally, other values may also be selected.

In an alternative design or as a supplement thereto, it is also advantageous if the first charge status, the second charge status and/or the additional charge statuses correspond to the charge status of a battery, which does not have the lowest charge status before the beginning of the charging phase.

This variant of the invention is explained using an example in which three batteries having different initial charge statuses are charged. A first battery in this case is charged to 75%, a second battery to 50% and a third battery to 90%. According to the invention, charging is begun with the second battery. It is charged during a first charging phase to the second lowest charge status of the batteries, in this concrete example that is the 75% of the first battery. Then, the first and second batteries are charged to 90% during a second charging phase. Finally, all batteries are charged to 100%.

It is beneficial if the charging device includes a measuring device, which is prepared to detect the charge status of the batteries before the beginning of the first charging phase. In this way, it is possible for the charging device to determine which battery should be the first to start charging.

It is also advantageous if the charging device includes at least two battery bays, which are also called “charging cradles” or “charging bays” into which a battery can be respectively inserted or removed therefrom without a tool. In this way, the charging device is especially easy to operate. “Battery bay” should be understood within the scope of the invention as any type of device in which a battery may be inserted or introduced for the purpose of transferring energy. In principle, charging cables are also suitable for this purpose even though they are less convenient.

It is also advantageous if voltage transformers are arranged in the mobile electric appliance in the current path between the battery bays and the consumer. In the case of this variant of the invention, batteries with different voltages may be used to operate the mobile electric appliance. The voltage transformers may be used to transform the voltage of the batteries to a voltage required for the consumer. Depending upon the type of consumer, DC/DC converters and/or DC/AC converters are used.

It is also advantageous if the mobile electric appliance is configured as a vacuum cleaner. This is an advantage in particular if the vacuum cleaner is part of a set, which also includes at least one electric hand-held device as well as several batteries that are interchangeable between the at least one electric hand-held device and the at least one mobile electric appliance. Therefore, the set is made up of several modules, which can be combined with each other as needed. Most of the time, a vacuum cleaner is made of a movable base part and a suction nozzle connected via a suction hose therewith. Because the base part normally does not have to be lifted during vacuuming but is merely pulled along behind, a vacuum cleaner is very well suited as a central charging station for the relatively heavy batteries. In this way, it is possible for batteries to be charged conveniently at the construction site or in the household. On the one hand, an empty battery of an electric hand-held device (e.g., cordless screwdriver, cordless drill, cordless saw, cordless grinder, cordless planer, cordless table vacuum cleaner, cordless search lamp, cordless radio, etc.) may be interchanged for a fully charged one from the vacuum cleaner. On the other hand, the vacuum cleaner may also be operated independently, i.e., without being connected to the electrical supply system. Because of the measures according to the invention, the batteries are charged as quickly as possible to a base status so that they are quickly ready to be used again. The advantage of the invention is especially striking in this case. However, these advantages are not limited to vacuum cleaners, but also apply to additional displaceable or moveable devices or devices whose base part is only moved comparatively seldom. Another example of such a device is a high-pressure cleaner.

It is noted at this point that the variants listed for the method according to the invention and the resulting advantages also apply correspondingly to the charging device according to the invention, the mobile electric appliance according to the invention as well as to the set according to the invention and vice versa.

The above-mentioned embodiments and further developments of the invention may be combined in any manner.

The present invention is explained in more detail in the following on the basis of the exemplary embodiments indicated in the schematic figures.

### BRIEF DESCRIPTION OF THE DRAWINGS

FIG. 1 illustrates a first variant of the invention in the form of a charging diagram for four batteries;

FIG. 2 illustrates a second variant of the invention in the form of a modified charging diagram for four batteries;

FIG. 3 illustrates a circuit for charging four batteries; and

FIG. 4 illustrates a set according to the invention.

### DETAILED DESCRIPTION OF THE DRAWINGS

In the figures, the same or similar parts are provided with the same reference numbers and, unless indicated otherwise, functionally equivalent elements and features are provided with the same reference numbers but different indexes.

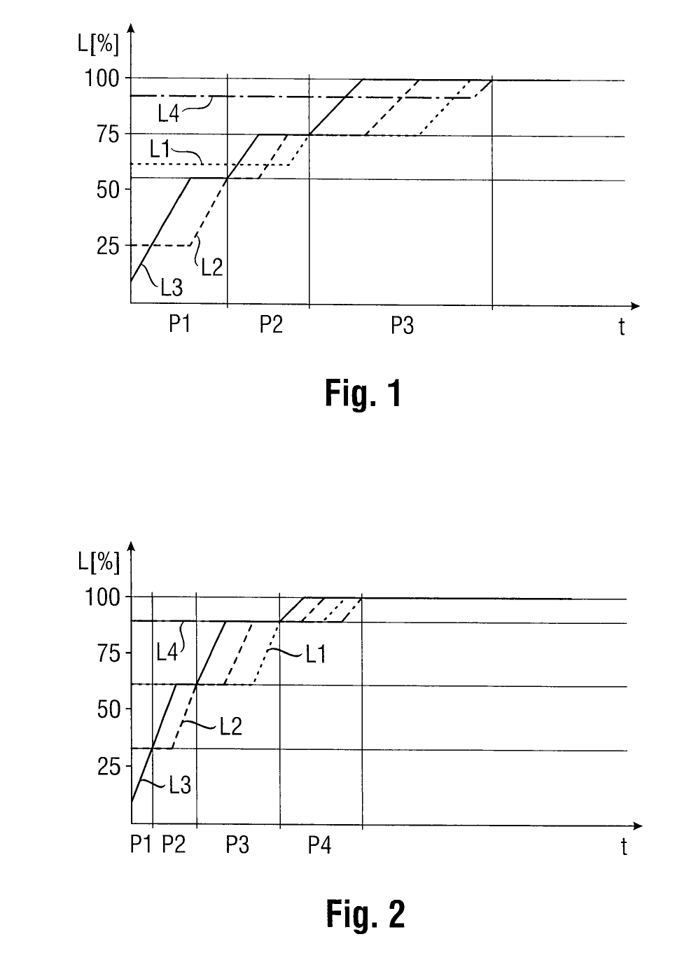

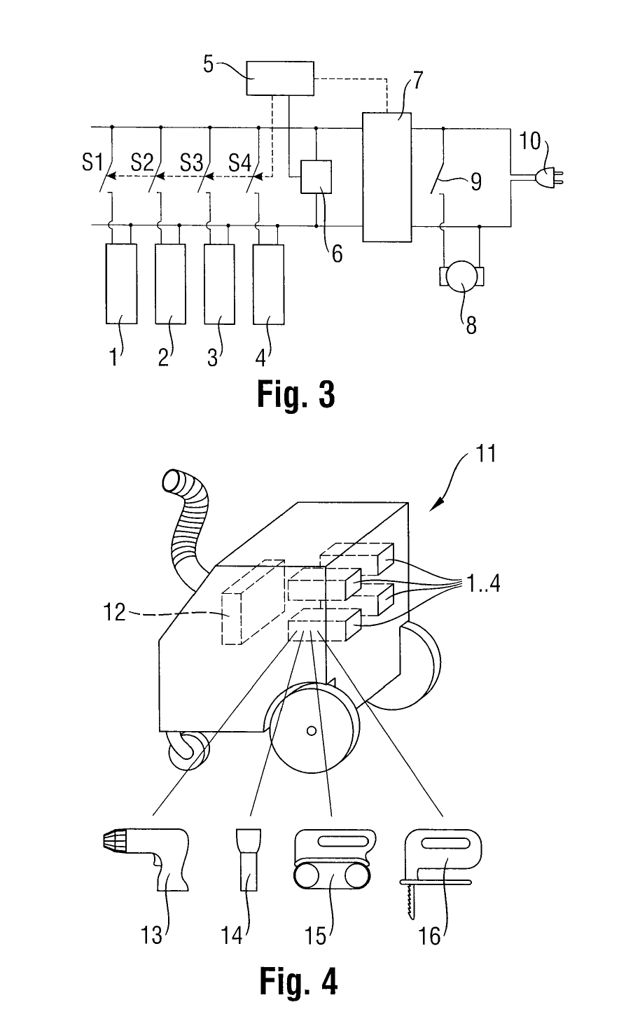

FIG. 1 shows a first variant of the invention in the form of a charging diagram for four batteries 1 . . . 4 (also see FIG. 3). In the diagram, the charge status L of the batteries 1 . . . 4 in percent is plotted over the time t. In this case, the dotted line indicates the charge status L1 of the first battery 1, the dashed line the charge status L2 of the second battery 2, the solid line the charge status L3 of the third battery 3 and the dashed-dotted line the charge status L4 of the fourth battery 4.

At the beginning of the charging process, the first battery 1 has a charge status L1 of approx. 65%, the second battery 2 a charge status L2 of approx. 25%, the third battery 3 a charge status L3 of approx. 10% and the fourth battery 4 a charge status L4 of approx. 90%.

During a first charging phase P1, all batteries 1 . . . 4 are now charged sequentially to a first charge status (in this case approx. 60%) and afterwards all batteries are charged during a second charging phase P2 sequentially to a second, higher charge status (in this case 75%), wherein the first charging phase P1 is begun with the battery having the lowest charge status (in this case the third battery 3). During the first charging phase P1, the third battery 3 and then the second battery 2 are charged to a first charge status of 60%. The first battery 1 and the fourth battery 4 remain untouched for the time being because their initial charge statuses L1, L4 are above 60% at any rate.

The batteries 3, 2 and 1 are charged to 75% according to the same scheme during the second charging phase P2. Finally the batteries 3, 2, 1 and 4 are charged to 100%.

As FIG. 1 clearly shows, the charging method according to the invention is recursively repeated with respectively increasing charge statuses until all batteries 1 . . . 4 are fully charged. Within the charging phases P1 . . . P3, the batteries 1 . . . 4 are also charged in ascending order of their charge statuses. For example, the first battery 1 is charged last during the second charging phase P2. In the present example, the order of the batteries 2 and 3 during the second phase P2 can be taken from the first phase P1, i.e., during the second charging phase P2, the third battery 3 is charged before the second battery 2. However, this does not absolutely have to be the case, because both batteries 2 and 3 already have the same charge status anyway at the beginning of the second charging phase P2. The sample applies to the batteries 1, 2 and 3 during the third charging phase P3.

The diagram in FIG. 1 makes the idea according to the invention clear to see, specifically the quickest possible charging of the batteries 1 . . . 4 to a base status. It also shows that the charging current decreases with increasing charge status L of the batteries 1 . . . 4 so that the charging curves get flatter and flatter. This means that the charging time of a charge status from 25% to 50% is shorter than the charging time from 75% to 100%. For this reason, the method according to the invention is advantageous, because this effect is utilized to transfer the energy as rapidly as possible to the batteries 1 . . . 4.

FIG. 2 now shows a somewhat modified form of the charging diagram depicted in FIG. 1. In contrast to FIG. 1, n charging phases are provided for n batteries, i.e., in a concrete case, four charging phases P1 . . . P4 are provided. In addition, the charge status upon completion of a charging phase P1 . . . P4 corresponds to the second lowest charge status of the batteries 1 . . . 4 before the beginning of this charging phase P1 . . . P4. In concrete terms, this means that the charge status L after completion of the first charging phase P1 corresponds to the charge status L2 of the second battery 2 before the beginning of the first charging phase P1, specifically 30%. Similarly, the charge status L upon completion of the second charging phase P2 corresponds to the charge status L1 of the first battery 1 before the beginning of the second charging phase P2, specifically 60%, etc. In this way, two or three batteries 1 . . . 4 may be charged to the same charge status L in the shortest possible time. However, in the case of a full charge, there is no advantage as compared to the method depicted in FIG. 1.

FIG. 3 depicts a circuit for charging four batteries 1 . . . 4. This circuit includes a controller 5, which is set up to control the method according to the invention, i.e., the sequence depicted in FIG. 1 or FIG. 2, for example. For this purpose, the circuit also has a measuring device 6, which is prepared to detect the charge status L1 . . . L4 of the batteries 1 . . . 4. In addition, the circuit includes a charge regulator 7 as well as a power connector 10. It is also assumed that the device depicted in FIG. 3 is a battery-operated electric appliance (e.g., a vacuum cleaner) so that the circuit also includes a consumer in the form of a motor 8 as well as a motor switch 9. Naturally, the last two components 8 and 9 mentioned are purely optional and do not contribute to the charging method according to the invention.

The function of the circuit depicted in FIG. 3 is as follows, wherein for the sake of simplicity we will begin with the pure charging operation, in which the power connector 10 is connected to the power supply system and the switch 9 is open.

The charge status L1 . . . L4 of the batteries 1 . . . 4 is determined prior to the actual charging. To do so, the controller 5 controls the charge regulator 7 to an inactive state, activates the switches S1 . . . S4 one after the other and uses the measuring device 6 to determine the charge statuses L1 . . . L4 of the batteries 1 . . . 4. In the simplest case, the measuring device 6 is a voltmeter, of course, other more complex devices or methods are also conceivable for determining a charge status L. Making reference to FIG. 1 or FIG. 2, the controller 5 now establishes that the third battery 3 has the lowest charge status L of the batteries 1 . . . 4. As a result, the controller 5 closes the switch S3 and activates the charge regulator 7. During charging, the measuring device 6 detects the charge status L3 of the third battery 3 on an ongoing basis. As soon as the third battery 3 is charged to the final charge status of the first charging phase P1, the switch S3 is opened and the switch S2 is closed in order to charge the second battery 2 to the same charge status L. This sequence is repeated in accordance with the diagram depicted in FIG. 1 or FIG. 2 so long or expanded to the other batteries 1 and 4 until all batteries 1 . . . 4 have been completely charged. As it is easy to see, the order of the batteries 1 . . . 4 during charging does not depend, as in the prior art, on the battery bay in which the respective battery 1 . . . 4 is inserted, rather the order is established, as explained, according to the charge status L.

While the device is connected to the power supply system, the motor 8 may also be supplied with electrical energy from the power supply network. If the device is disconnected, then energy may be drawn from the batteries 1 . . . 4 in a manner that is known per se. In order to bring batteries with a different nominal voltage or even a different charge status to the voltage level required by the motor 8, voltage transformers (not shown) may be arranged in the current path between the batteries 1 . . . 4 inserted into the battery bays and the motor 8. If the batteries 1 . . . 4 are discharged sequentially, e.g., beginning with the battery 1 . . . 4 with the highest charge status L1 . . . L4 and arranged in the order of falling charge statuses L1 . . . L4, a voltage transformer is sufficient in principle, and the transformer transforms the voltage of the battery 1 . . . 4 selected by one of the switches S1 . . . S4 to the voltage required by the motor 8. If several or all batteries 1 . . . 4 are discharged simultaneously, then a separate voltage transformer must be provided for each battery 1 . . . 4, which is connected on the output-side or motor-side to a common connection point.

FIG. 4 now shows an example of a set according to the invention comprising at least one mobile electric appliance, in this case formed by a vacuum cleaner 11, and at least four batteries 1 . . . 4. The set advantageously includes at least one electric hand-held device with a battery bay for accommodating one of the batteries 1 . . . 4. Purely as an example, a cordless screwdriver 13, a flashlight 14, a belt sander 15 as well as a compass saw 16 are provided as electric hand-held devices of the set. Up to four batteries 1 . . . 4 may be inserted into the vacuum cleaner 11, which may be charged there or used to operate the vacuum cleaner 11. Situated in the forward portion of the vacuum cleaner 11 is also a suction controller 12, which is provided for the controller of the vacuum cleaner 11 and may include the circuit depicted in FIG. 3, for example. The advantages of the invention are especially striking in this case.

Finally, reference is made to the fact that the figures are not to scale in some cases and were also drawn in a very simplified manner. A circuit (FIG. 3) in a real application or a vacuum cleaner (FIG. 4) in a real application may therefore contain more components than are shown here and may therefore be constructed in a considerably more complex manner than is depicted in the figures. Parts of the arrangements depicted in the figures may also form the basis for independent inventions.

The following list of reference numbers and the technical teachings of the patent claims are considered to be within the scope of the disclosure and disclose additional details of the invention and its exemplary embodiments to a person skilled in the art by themselves or in conjunction with the figures.

List of Reference Numbers:

1 . . . 4 Battery

5 Controller

6 Measuring device

7 Charge regulator

8 Consumer (motor)

9 Motor switch

10 Power connector

11 Vacuum cleaner

12 Suction controller

13 Cordless screwdriver

14 Flashlight

15 Belt sander

16 Compass saw

L1 . . . L4 Charge status of batteries 1 . . . 4

P1 . . . P4 Charging phases

t Time

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for charging at least two batteries each having at least one cell, comprising the steps of:
charging one or more of the at least two batteries sequentially to a first charge status during a first charging phase; and
after the first charging phase, charging one or more of the at least two batteries sequentially to a second charge status, wherein the second charge status is higher than the first charge status;
wherein the first charging phase is begun with a battery of the one or more of the at least two batteries that has a lowest charge status.

2. The method according to claim 1, wherein during the first charging phase, the one or more of the at least two batteries has a charge status that falls short of the first charge status and wherein during the second charging phase, the one or more of the at least two batteries has a charge status that falls short of the second charge status.

3. The method according to claim 1, further comprising the step of charging one or more of the at least two batteries sequentially during an additional charging phase that have a charge status that falls short of an additional charge status to the additional charge status, wherein the additional charge status is higher than the first and the second charge status.

4. The method according to claim 1, further comprising the step of terminating charging of the at least two batteries when all of the at least two batteries have a charge status of 100%.

5. The method according to claim 1, wherein during the first charging phase, the one or more of the at least two batteries are charged in an ascending order of a respective charge status before a beginning of the first charging phase.

6. The method according to claim 3, wherein during the second charging phase and the additional charging phase, the one or more of the at least two batteries are charged in an ascending order of a respective charge status before a beginning of the first charging phase.

7. The method according to claim 3, wherein the first charge status, the second charge status, and/or the additional charge status are/is predetermined as a percentage value and/or correspond to a charge status of a battery of the at least two batteries that does not have a lowest charge status before a beginning of the charging phases.

8. A charging device for charging at least two batteries each having at least one cell, comprising:
a controller, wherein during a first charging phase, all batteries of the at least two batteries that have a charge status that falls short of a first charge status are chargeable sequentially to the first charge status by the controller, wherein after the first charging phase, during a second charging phase, all batteries of the at least two batteries that have a charge status that falls short of a second charge status are chargeable sequentially to the second charge status by the controller, wherein the second charge status is higher than the first charge status, and wherein the controller is configured such that the first charging phase is commenced by the controller with a battery that has a lowest charge status.

9. The charging device according to claim 8, wherein the batteries that are chargeable by the controller during the first charging phase are chargeable in an ascending order of a respective charge status.

10. The charging device according to claim 8, further comprising a measuring device, wherein a charge status of the at least two batteries is detectable by the measuring device before a beginning of the first charging phase.

11. The charging device according to claim 8, further comprising at least two battery bays coupled to the controller.

12. A mobile electric appliance in combination with the charging device according to claim 8.

13. The mobile electric appliance according to claim 12, wherein the mobile electric appliance is a vacuum cleaner.

14. The mobile electric appliance according to claim 12, wherein the mobile electric appliance includes at least one electric hand-held device and a plurality of interchangeable batteries.

15. The mobile electric appliance according to claim 14, wherein the at least one electric hand-held device includes a battery bay for accommodating at least one interchangeable battery of the plurality of interchangeable batteries.
